(19) United States
(12) Patent Application Publication
(10) Pub. No.: US 2026/0318328 A1
(43) Pub. Date: Oct. 15, 2026

(54) FLUID PRESSURE CYLINDER UNIT

(71) Applicant: KYB Corporation, Tokyo (JP)

(72) Inventor: Kazuki HASEGAWA, Gifu (JP)

(73) Assignee: KYB Corporation, Tokyo (JP)

(21) Appl. No.: 19/112,023

(22) PCT Filed: Oct. 19, 2023
(86) PCT No.: PCT/JP2023/037834

§ 371 Date: Mar. 14, 2025

(30) Foreign Application Priority Data
Nov. 4, 2022 (JP) 2022-177559

(51) Int. Cl. F15B 11/072; F15B 1/04; F15B 15/14

(52) U.S. Cl. CPC F15B 11/072; F15B 1/04; F15B 15/1457

(57) ABSTRACT

A fluid pressure cylinder unit includes a fluid pressure cylinder having a cylinder tube and a piston rod; an accumulator having a gas chamber capable of being filled with a gas and a liquid chamber capable of being filled with a liquid; and a first passage through which the first chamber is communicated with the gas chamber of the accumulator. The gas is filled into the first chamber the piston rod reciprocates as a working fluid is supplied to and discharged from the second chamber. The first passage is provided with a valve capable of allowing only a flow of the gas from the first chamber to the gas chamber of the accumulator.

### TECHNICAL FIELD

The present invention relates to a fluid pressure cylinder unit.

### BACKGROUND ART

JP2016-176566A discloses a fluid pressure cylinder having: a cylinder tube with a bottomed cylindrical shape having an opening portion at one end; a rod that is inserted into the cylinder tube; and a piston that is connected to a tip end of the rod and that divides an interior of the cylinder tube into a rod side chamber that is filled with gas and a bottom-side chamber to/from which a working fluid is supplied/discharged. The gas is filled into the rod side chamber, and a working oil is supplied and discharged to and from the bottom-side chamber. The fluid pressure cylinder is extended by a working oil pressure that is guided from a hydraulic pressure source to the bottom-side chamber.

### SUMMARY OF INVENTION

In the fluid pressure cylinder as described in JP2016-176566A, when the fluid pressure cylinder is extended, the gas in the rod side chamber is pressurized and discharged to a tank, etc. The high-pressure gas is only discharged to the tank, etc. and is not effectively utilized.

An object of the present invention is to effectively utilize a high-pressure gas discharged from a first chamber of a fluid pressure cylinder.

According to one aspect of the present invention, a fluid pressure cylinder unit includes: a fluid pressure cylinder having a cylinder tube and a piston rod provided in the cylinder tube so as to be reciprocatable, the piston rod dividing an interior of the cylinder tube into a first chamber and a second chamber; an accumulator having a gas chamber capable of being filled with a gas and a liquid chamber capable of being filled with a liquid; and a first passage through which the first chamber is communicated with the gas chamber of the accumulator. The gas is filled into the first chamber, the piston rod reciprocates as a working fluid is supplied to and discharged from the second chamber, and the first passage is provided with a valve capable of allowing only a flow of the gas from the first chamber to the gas chamber of the accumulator.

### BRIEF DESCRIPTION OF DRAWINGS

FIG. 1 is a circuit diagram of a fluid pressure cylinder unit according to an embodiment of the present invention.

FIG. 2 is a diagram showing an operation of the fluid pressure cylinder unit according to the embodiment of the present invention and filling of gas into an accumulator.

FIG. 3 is a circuit diagram of the fluid pressure cylinder unit according to a first modification of the embodiment of the present invention.

FIG. 4 is a circuit diagram of the fluid pressure cylinder unit according to a second modification of the embodiment of the present invention.

FIG. 5 is a circuit diagram of the fluid pressure cylinder unit according to a third modification of the embodiment of the present invention.

### DESCRIPTION OF EMBODIMENTS

A fluid pressure cylinder unit 101 according to an embodiment of the present invention will be described with reference to the drawings. The fluid pressure cylinder unit 101 includes a fluid pressure cylinder and an accumulator 40 that is connected to the fluid pressure cylinder. In this embodiment, a case in which the fluid pressure cylinder is a lift cylinder 100 that moves a fork of a forklift truck up and down will be described.

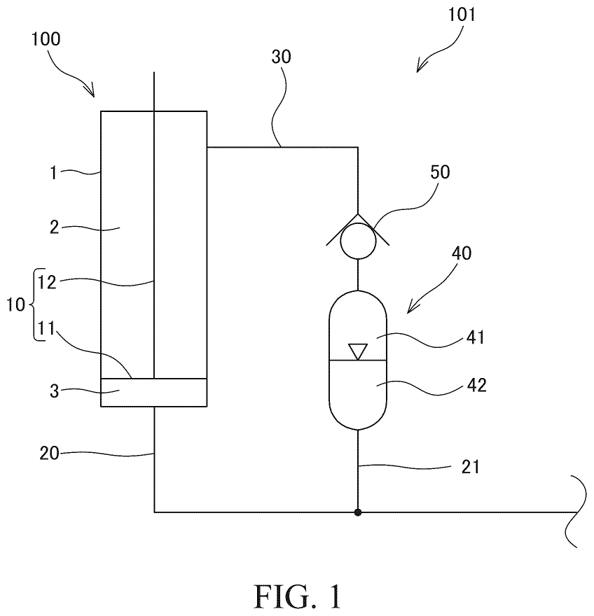

The lift cylinder 100 is a single-acting type hydraulic cylinder. As shown in FIG. 1, the lift cylinder 100 has: a cylinder tube 1; a piston rod 10 that is provided in the cylinder tube 1 so as to be reciprocatable and so as to divide an interior of the cylinder tube 1 into a rod side chamber 2 serving as a first chamber and an anti-rod side chamber 3 serving as a second chamber; a first passage 30 that is connected to the rod side chamber 2; and a main passage 20 that is connected to the anti-rod side chamber 3.

The piston rod 10 has a piston 11 that is provided so as to be slidable along an inner circumferential surface of the cylinder tube 1 and a rod 12 that reciprocates and that has a first end linked to the piston 11 and a second end extending to the outside of the cylinder tube 1. Gas, such as air, etc. is filled into the rod side chamber 2. Note that the term “filled” includes a case in which the gas is actively charged into the rod side chamber 2 by using a gas cylinder, etc. and a case in which the gas is mixed into the rod side chamber 2 during assembly of the lift cylinder 100. The gas is discharged from the rod side chamber 2 through the first passage 30. A working oil serving as a working fluid is supplied to and discharged from the anti-rod side chamber 3 through the main passage 20. Note that liquids, such as water, etc., other than the working oil may also be used as the working fluid.

The main passage 20 is provided with a switching valve (not shown), and the main passage 20 is connected to a pump (not shown) or a tank (not shown) by switching the switching valve. In the lift cylinder 100, the piston rod 10 is moved in a reciprocating manner as the working oil is supplied to and discharged from the anti-rod side chamber 3 through the main passage 20. Specifically, when the working oil is supplied to the anti-rod side chamber 3 from a hydraulic pressure source, the piston rod 10 is moved upward (the upward direction in FIG. 1) and the lift cylinder 100 is extended, and thereby, the fork and the cargo placed on the fork are lifted. When the working oil is discharged from the anti-rod side chamber 3 to the tank due to the self-weight of the fork, the cargo, and the piston rod 10, the piston rod 10 is moved downward (the downward direction in FIG. 1) and the lift cylinder 100 is contracted, and thereby, the fork and the cargo are lowered.

In addition, the accumulator 40 has a gas chamber 41 into which the gas can be filled and a liquid chamber 42 into which the liquid can be filled. The accumulator 40 is provided separately from the lift cylinder 100. Note that the gas chamber 41 and the liquid chamber 42 may be divided from each other by a partition member such as a free piston, a bladder, and so forth. The gas chamber 41 is connected to the first passage 30, and the liquid chamber 42 is connected to a branch passage 21 that is branched from the main passage 20. As described above, the rod side chamber 2 and the gas chamber 41 are communicated via the first passage 30, and the anti-rod side chamber 3 and the liquid chamber 42 are communicated via the main passage 20 and the branch passage 21. The first passage 30 is provided with a check valve 50 serving as a valve capable of allowing only a flow of the gas from the rod side chamber 2 to the gas chamber 41 of the accumulator 40. Note that, in place of the check valve 50, an solenoid valve, a manual valve, or the like may be provided. In addition, the anti-rod side chamber 3 and the liquid chamber 42 may be communicated via a passage that is provided in parallel with the main passage 20.

The fluid pressure cylinder unit 101 of this embodiment is assembled by connecting the lift cylinder 100 and the accumulator 40 under an atmospheric condition. Before the lift cylinder 100 is connected to the accumulator 40, the pressure in the gas chamber 41 of the accumulator 40 is at atmospheric pressure and the high-pressure gas is not filled into the gas chamber 41. The gas chamber 41 of the accumulator 40 is filled with the high-pressure gas by an initial operation of the lift cylinder 100 that is performed after the lift cylinder 100 is connected to the accumulator 40.

Next, the filling of the high-pressure gas into the gas chamber 41 of the accumulator 40 will be described in detail.

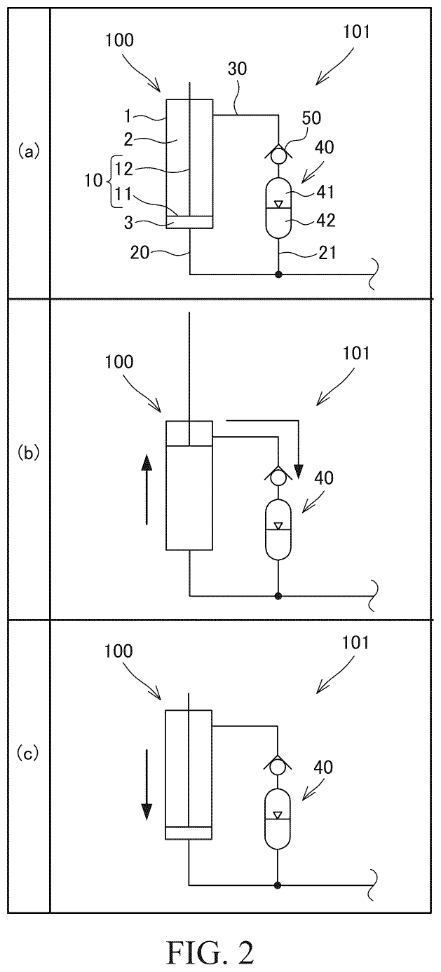

FIG. 2(a) to (c) are each a diagram showing the initial operation of the lift cylinder 100, and FIG. 2(a) shows a state before the initial operation of the lift cylinder 100 is performed (in other words, immediately after the lift cylinder 100 is connected to the accumulator 40). In this state, due to the self-weight of the piston rod 10, the lift cylinder 100 is in the fully contracted state. The pressure in the rod side chamber 2 and the pressure in the gas chamber 41 of the accumulator 40 are equal to the atmospheric pressure, and the high-pressure gas is not filled into the gas chamber 41.

As shown in FIG. 2(b), the initial operation of the lift cylinder 100 is performed by extending (specifically, fully extending) the lift cylinder 100 by supplying the working oil from the hydraulic pressure source to the anti-rod side chamber 3 through the main passage 20. As a result, as indicated by the arrow on the right side in FIG. 2(b), the gas inside the rod side chamber 2 is pressurized and guided to the gas chamber 41 of the accumulator 40 through the first passage 30 and the check valve 50. Then, the high-pressure gas is filled into the gas chamber 41 until the pressure in the gas chamber 41 reaches the set pressure.

Subsequently, when the working oil is discharged from the anti-rod side chamber 3, as shown in FIG. 2(c), the lift cylinder 100 is contracted to the fully contracted state by the self-weight of the piston rod 10, the initial operation of the lift cylinder 100 is completed. In this state, because the capacity of the rod side chamber 2 is increased compared to the state shown in FIG. 2(b), the pressure in the rod side chamber 2 is decreased. However, because the check valve 50 is provided in the first passage 30, the gas filled into the gas chamber 41 of the accumulator 40 is not guided to the rod side chamber 2 through the first passage 30. Thus, the pressure in the gas chamber 41 of the accumulator 40 is held at the set pressure. Note that the above-described operations illustrated in FIG. 2(a) to (c) may be performed before or after the fluid pressure cylinder unit 101 is mounted on the forklift truck. In addition, the operations illustrated in FIG. 2(a) to (c) may be performed at the time of an operation test of the lift cylinder 100 or at the time of air venting of the anti-rod side chamber 3. In addition, in a case in which the solenoid valve, the manual valve, or the like is provided in place of the check valve 50, it is sufficient to have a configuration in which, the rod side chamber 2 is communicated with the gas chamber 41 of the accumulator 40 via the first passage 30 when the lift cylinder 100 is extended, and the communication between the rod side chamber 2 and the gas chamber 41 of the accumulator 40 is shut off when the lift cylinder 100 is contracted. Even with this configuration, the solenoid valve, the manual valve, or the like can allow only the flow of the gas from the rod side chamber 2 to the gas chamber 41 of the accumulator 40.

In a normal operation of the lift cylinder 100, the fluid pressure cylinder unit 101 is mounted on the forklift truck, and the cargo transport and cargo handling operations are performed. In the normal operation of the lift cylinder 100, although the pressure in the rod side chamber 2 is lower than the pressure in the gas chamber 41 of the accumulator 40 until the lift cylinder 100 reaches the fully extended state, the pressure in the gas chamber 41 of the accumulator 40 is maintained by the check valve 50. In addition, when the lift cylinder 100 reaches the fully extended state, the pressure in the rod side chamber 2 becomes equal to that in the state shown in FIG. 2(b), in other words, it becomes equal to the pressure in the gas chamber 41 of the accumulator 40. As described above, in the normal operation of the lift cylinder 100, the gas in the rod side chamber 2 is not guided to the gas chamber 41 of the accumulator 40. In other words, in the fluid pressure cylinder unit 101, only when the lift cylinder 100 is extended (specifically, fully extended) for the first time after the lift cylinder 100 is connected to the accumulator 40, the gas in the rod side chamber 2 is pressurized and filled into the gas chamber 41 of the accumulator 40.

As described above, in the lift cylinder 100, in the initial operation of the lift cylinder 100, as the lift cylinder 100 is extended, the gas filled in the rod side chamber 2 is pressurized, and is guided to and filled into the gas chamber 41 of the accumulator 40 through the first passage 30 and the check valve 50. As a result, it is possible to effectively utilize the high-pressure gas discharged from the rod side chamber 2 as the gas to be filled into the gas chamber 41 of the accumulator 40.

In addition, in the accumulator 40, because the gas chamber 41 is filled with the high-pressure gas for the first time at the time of the initial operation of the lift cylinder 100, the high-pressure gas is not filled into the gas chamber 41 before the operation of the lift cylinder 100. Therefore, it is possible to handle the accumulator 40 safely and easily. In addition, when the accumulator 40 is to be transported, it is possible to transport the accumulator 40 safely and easily. Furthermore, because the gas in the rod side chamber 2 is filled into the gas chamber 41 of the accumulator 40 by being pressurized, there is no need to utilize a gas cylinder, etc. in order to fill the high-pressure gas into the gas chamber 41. Therefore, compared with a case in which the gas cylinder, etc. is utilized, it is possible to handle the accumulator 40 safely and easily, and manufacturing costs are reduced.

In addition, in the fluid pressure cylinder unit 101, because the anti-rod side chamber 3 is communicated with the liquid chamber 42 of the accumulator 40 via the main passage 20 and the branch passage 21, the pressure fluctuations in the main passage 20 and the anti-rod side chamber 3 is absorbed by the accumulator 40. Therefore, even if, for example, an impact exerted from a road surface acts on the lift cylinder 100 during the cargo transport by the forklift truck, the vibration of the cargo can be absorbed by the accumulator 40. Accordingly, it is possible to prevent a cargo shifting during the cargo transport.

According to the above-described embodiment, following operational advantages are afforded.

In the lift cylinder 100, as the lift cylinder 100 is extended, the gas filled into the rod side chamber 2 is pressurized, and is guided to and filled into the gas chamber 41 of the accumulator 40 through the first passage 30 and the check valve 50. As a result, it is possible to effectively utilize the high-pressure gas discharged from the rod side chamber 2 as the gas to be filled into the gas chamber 41 of the accumulator 40.

In the lift cylinder 100, the anti-rod side chamber 3 is communicated with the liquid chamber 42 of the accumulator 40 via the main passage 20. Thus, it is possible to absorb, by means of the accumulator 40, the vibration of the cargo, etc., which is the object to be driven by the lift cylinder 100.

In the fluid pressure cylinder unit 101, because the high-pressure gas is filled into the gas chamber 41 of the accumulator 40 for the first time at the time of the initial operation of the lift cylinder 100 after the lift cylinder 100 is connected to the accumulator 40, the high-pressure gas is not filled in the gas chamber 41 before the operation of the lift cylinder 100. Therefore, it is possible to handle the accumulator 40 safely and easily. In addition, even when the accumulator 40 is to be transported, it is possible to transport the accumulator 40 safely and easily.

Following modifications are also within the scope of the present invention, and it is also possible to combine the configurations shown in the modifications with the configurations described in the above-described embodiment, and to combine the configurations described in the following different modifications.

### First Modification

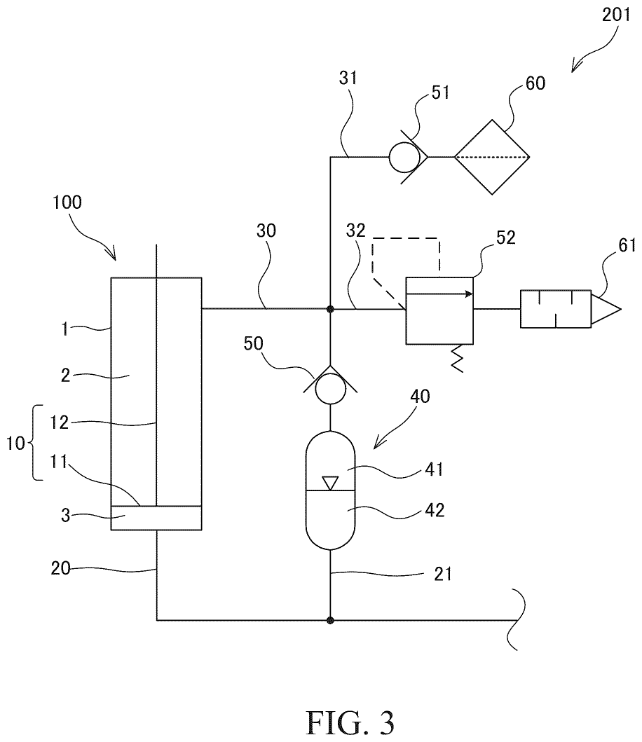

In the above-mentioned embodiment, the fluid pressure cylinder unit 101 includes the first passage 30 through which the rod side chamber 2 and the gas chamber 41 of the accumulator 40 are communicated. In addition, as shown in FIG. 3, a fluid pressure cylinder unit 201 according to a first modification includes a second passage 31 that is connected to the first passage 30 at a point between the rod side chamber 2 and the check valve 50 and that is communicated with the atmosphere.

The second passage 31 is communicated with the atmosphere via a filter 60. A check valve 51 that allows only the flow of the gas from the atmosphere to the first passage 30 is provided in the second passage 31. Thus, when the pressure in the rod side chamber 2 and the first passage 30 is reduced (specifically, becomes lower than the atmospheric pressure) during contraction of the lift cylinder 100, the gas is supplied to the rod side chamber 2 and the first passage 30 through the filter 60, the second passage 31, and the check valve 51. As a result, each time the lift cylinder 100 is extended, it is possible to repeatedly fill the gas in the rod side chamber 2 into the gas chamber 41 of the accumulator 40. Therefore, it is possible to prevent the decrease in the pressure in the gas chamber 41.

Furthermore, the fluid pressure cylinder unit 201 includes a third passage 32 that is connected to the first passage 30 at the point between the rod side chamber 2 and the check valve 50. The third passage 32 is communicated with the atmosphere via a silencer 61. A relief valve 52, which is opened when the pressure in the first passage 30 reaches a predetermined pressure, is provided in the third passage 32. When the relief valve 52 is opened, the gas in the rod side chamber 2 and the first passage 30 is discharged to the atmosphere through the third passage 32 and the silencer 61. The pressure at which the relief valve 52 is opened is, for example, set so as to be equal to the set pressure of the accumulator 40. Thus, the pressure in the rod side chamber 2 and the first passage 30 does not become higher than the set pressure of the accumulator 40. In other words, the gas is prevented from being filled into the gas chamber 41 of the accumulator 40 at a pressure higher than or equal to the set pressure during the operation of the lift cylinder 100, and thereby, the pressure in the gas chamber 41 is prevented from becoming higher than or equal to the set pressure.

Note that the third passage 32 may be communicated with the tank instead of the atmosphere. In addition, it is not necessary that both the second passage 31 and the third passage 32 be provided, and only one of them may be provided. In addition, the filter 60 and the silencer 61 are not essential components, and they may not be provided.

### Second Modification

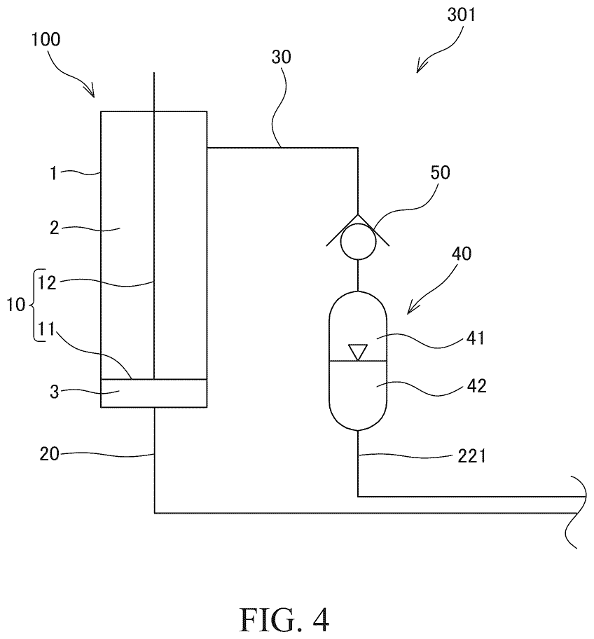

In the above-mentioned embodiment, in the fluid pressure cylinder unit 101, the anti-rod side chamber 3 is communicated with the liquid chamber 42 of the accumulator 40 via the main passage 20 and the branch passage 21. In contrast, as shown in FIG. 4, in a fluid pressure cylinder unit 301, the anti-rod side chamber 3 is not communicated with the liquid chamber 42 of the accumulator 40, and the liquid chamber 42 of the accumulator 40 is connected to another device (not shown) separate from the lift cylinder 100 via a passage 221. Even with such a configuration, it is possible to effectively utilize the high-pressure gas discharged from the rod side chamber 2 as the gas to be filled into the gas chamber 41 of the accumulator 40. In addition, by the accumulator 40, it is possible to absorb the vibration of the another device to which the accumulator 40 is connected.

### Third Modification

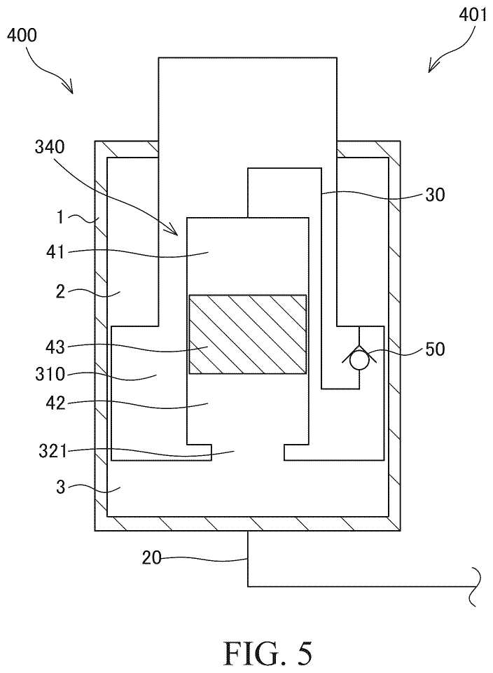

In the above-mentioned embodiment, the accumulator 40 is provided separately from the lift cylinder 100. In contrast, in a fluid pressure cylinder unit 401 according to a third modification, the accumulator 40 is provided in the piston rod 10. Specifically, as shown in FIG. 5, an accumulator 340 has a free piston 43 serving as a partitioning member that divides the gas chamber 41 and the liquid chamber 42 from each other, and the first passage 30, the check valve 50, the free piston 43, and a passage 321 through which the anti-rod side chamber 3 and the liquid chamber 42 are communicated are provided in a piston rod 310. Even with such a configuration, when a lift cylinder 400 is extended by supplying the working oil from the hydraulic pressure source to the anti-rod side chamber 3, the gas in the rod side chamber 2 is pressurized, and is guided to and filled into the gas chamber 41 of the accumulator 340 through the first passage 30 and the check valve 50. In addition, because the anti-rod side chamber 3 is communicated with the liquid chamber 42 of the accumulator 340 via the passage 321, the pressure fluctuations in the main passage 20 and the anti-rod side chamber 3 is absorbed by the accumulator 340, and so, it is possible to prevent a cargo shifting during the cargo transport. As described above, by providing the accumulator 340 in the piston rod 310, it is possible to make the fluid pressure cylinder unit 401 compact.

### Fourth Modification

In the above-mentioned embodiment, in the fluid pressure cylinder unit 101, the gas is filled into the rod side chamber 2, and the rod side chamber 2 is communicated with the gas chamber 41. In addition, the anti-rod side chamber 3 is communicated with the liquid chamber 42, and the working oil supplied to and discharged from the anti-rod side chamber 3. The present invention is not limited thereto, and in the fluid pressure cylinder unit 101, it may be possible to employ a configuration in which the gas is filled into the anti-rod side chamber 3, the anti-rod side chamber 3 is communicated with the gas chamber 41, the rod side chamber 2 is communicated with the liquid chamber 42, and the working oil is supplied to and discharged from the rod side chamber 2. With this configuration, the gas in the anti-rod side chamber 3 is pressurized and filled into the gas chamber 41 of the accumulator 40 when the lift cylinder 100 is contracted (specifically, fully contracted) for the first time after the lift cylinder 100 is connected to the accumulator 40. In addition, the fluid pressure cylinder unit 101 may also be used in an upside-down orientation relative to the orientation shown in FIG. 1.

### Fifth Modification

In the above-mentioned embodiment, the description has been given for the case in which the fluid pressure cylinder is the lift cylinder 100 that moves the fork of the forklift truck up and down. The present invention is not limited thereto, and the fluid pressure cylinder may be a cylinder other than the cylinder mounted on the forklift truck, as long as the gas is filled into the one of the rod side chamber 2 or the anti-rod side chamber 3, and the piston rod 10 is caused to reciprocate by supplying and discharging the working fluid to and from the other. In addition, the fluid pressure cylinder may be a double-rod type cylinder.

The configurations, operations, and effects of the embodiments of the present invention configured as described above will be collectively described.

The fluid pressure cylinder unit 101, 201, 301, 401 includes: the lift cylinder 100, 400 serving as the fluid pressure cylinder having the cylinder tube 1 and the piston rod 10, 310 provided in the cylinder tube 1 so as to be reciprocatable, the piston rod 10, 310 dividing the interior of the cylinder tube 1 into the first chamber and the second chamber; the accumulator 40, 240 having the gas chamber 41 capable of being filled with the gas and the liquid chamber 42 capable of being filled with the liquid; and the first passage 30 through which the first chamber is communicated with the gas chamber 41 of the accumulator 40, 340. The gas is filled into the first chamber, the piston rod 10, 310 reciprocates as a working fluid is supplied to and discharged from the second chamber, and the first passage 30 is provided with the check valve 50 serving as the valve capable of allowing only the flow of the gas from the first chamber to the gas chamber 41 of the accumulator 40, 340.

With this configuration, when the lift cylinder 100, 400 is extended, the gas filled into the first chamber is pressurized, and is guided to and filled into the gas chamber 41 of the accumulator 40, 340 through the first passage 30 and the check valve 50. As a result, it is possible to effectively utilize the high-pressure gas discharged from the first chamber as the gas to be filled into the gas chamber 41 of the accumulator 40, 340.

In addition, in the fluid pressure cylinder unit 101, 201, 401, the second chamber is communicated with the liquid chamber 42 of the accumulator 40, 340.

With this configuration, the second chamber is communicated with the liquid chamber 42 of the accumulator 40, 340. Thus, it is possible to absorb the vibration of the object to be driven by the lift cylinder 100, 400 by the accumulator 40, 340.

In addition, the fluid pressure cylinder unit 201 further includes the second passage 31 connected to the first passage 30 at the point between the first chamber and the check valve 50, the second passage 31 communicating with the atmosphere. The second passage 31 is provided with the check valve 51, the check valve 51 being configured to allow only the flow of the gas from the atmosphere to the first passage 30.

With this configuration, it is possible to prevent the decrease in the pressure in the gas chamber 41 of the accumulator 40.

In addition, the fluid pressure cylinder unit 201 further includes the third passage 32 connected to the first passage 30 at the point between the first chamber and the check valve 50. The third passage 32 is provided with the relief valve 52 opening when the pressure in the first passage 30 reaches a predetermined pressure.

With this configuration, the pressure in the gas chamber 41 of the accumulator 40 is prevented from becoming higher than or equal to the set pressure.

In addition, in the fluid pressure cylinder unit 401, the accumulator 340 further has the free piston 43 serving as the partitioning member, the partitioning member dividing the gas chamber 41 and the liquid chamber 42 from each other, and the first passage 30, the check valve 50, and the free piston 43 are provided in the piston rod 310.

With this configuration, it is possible to make the fluid pressure cylinder unit 401 compact.

In addition, in the fluid pressure cylinder unit 101, 201, 301, 401, the gas in the first chamber is pressurized and filled into the gas chamber 41 of the accumulator 40, 340 when the lift cylinder 100, 400 is extended or contracted for the first time after the lift cylinder 100, 400 is connected to the accumulator 40, 340.

With this configuration, before performing the operation of the lift cylinder 100, 400, the high-pressure gas is not filled into the gas chamber 41. Therefore, it is possible to handle the accumulator 40, 340 safely and easily.

Embodiments of the present invention were described above, but the above embodiments are merely examples of applications of the present invention, and the technical scope of the present invention is not limited to the specific constitutions of the above embodiments.

With respect to the above description, the contents of application No. 2022-177559, with a filing date of Nov. 4, 2022, in Japan, are incorporated herein by reference.

1. A fluid pressure cylinder unit comprising:
a fluid pressure cylinder configured to drive a driving target, the fluid pressure cylinder having a cylinder tube and a piston rod provided in the cylinder tube so as to be reciprocatable, the piston rod dividing an interior of the cylinder tube into a first chamber and a second chamber;
an accumulator having a gas chamber capable of being filled with a gas and a liquid chamber capable of being filled with a liquid; and
a first passage through which the first chamber is communicated with the gas chamber of the accumulator, wherein
the gas is filled into the first chamber,
the piston rod reciprocates as a working fluid is supplied to and discharged from the second chamber,
the second chamber is constantly communicated with the liquid chamber of the accumulator, and
the first passage is provided with a valve capable of allowing only a flow of the gas from the first chamber to the gas chamber of the accumulator.

2. (canceled)

3. The fluid pressure cylinder unit according to claim 1, further comprising
a second passage connected to the first passage at a point between the first chamber and the valve, the second passage communicating with an atmosphere, wherein
the second passage is provided with a check valve, the check valve being configured to allow only a flow of the gas from the atmosphere to the first passage.

4. The fluid pressure cylinder unit according to claim 1, further comprising
a third passage connected to the first passage at a point between the first chamber and the valve, wherein
the third passage is provided with a relief valve, the relief valve being configured to be opened when a pressure in the first passage reaches a predetermined pressure.

5. The fluid pressure cylinder unit according to claim 1, wherein
the accumulator further has a partitioning member dividing the gas chamber and the liquid chamber from each other, and
the first passage, the valve, and the partitioning member are provided in the piston rod.

6. The fluid pressure cylinder unit according to claim 1, wherein
the gas in the first chamber is pressurized and filled into the gas chamber of the accumulator when the fluid pressure cylinder is extended or contracted for a first time after the fluid pressure cylinder is connected to the accumulator.
